(19) United States
(12) Patent Application Publication
(10) Pub. No.: US 2015/0281756 A1
(43) Pub. Date: Oct. 1, 2015

(54) DATA SESSION MANAGEMENT METHOD AND SYSTEM INCLUDING CONTENT RECOGNITION OF BROADCAST DATA AND REMOTE DEVICE FEEDBACK

(71) Applicants: PATRICK SOON-SHIONG, (US); NANTX TECHNOLOGIES LTD, Kfar-Saba (IL)

(72) Inventors: PATRICK SOON-SHIONG, LOS ANGELES, CA (US); SHAY HILEL, Tel Mond (IL); ERAN MOSS, Kochav Yair (IL)

(21) Appl. No.: 14/668,604

(22) Filed: Mar. 25, 2015

Related U.S. Application Data
(60) Provisional application No. 61/970,799, filed on Mar. 26, 2014.

(51) Int. Cl. H04N 21/2668; H04N 21/442; H04N 21/81; H04N 21/258; H04N 21/235; H04N 21/237; H04N 21/41; H04N 21/466

(52) U.S. Cl. CPC H04N 21/2668; H04N 21/4126; H04N 21/44213; H04N 21/4667; H04N 21/25866; H04N 21/235; H04N 21/237; H04N 21/812

(57) ABSTRACT

Computer-implemented methods and systems of session management of data between a content management server and a plurality of interconnected remote devices over network are presented. The remote devices, such as mobile devices, detect broadcast information from a television that is in range of cameras and microphones. An agent on remote devices uses automatic content recognition to identify broadcast information. The recognized broadcast data and user interaction data, are transmitted through a network to a trends database. The server coupled to the trends database and a broadcast information database correlates data to derive content relevant analytics data. The analytics data is provided to subscribers to show viewing trends and said subscribers can push content to the remote devices by a number of means. The collected analytics data is presented to subscribers through a GUI that allows subscribers determine relevance and value.

### CROSS-REFERENCE TO RELATED APPLICATIONS

This application relates to the claims and benefit of U.S. Provisional Patent application No. 61/970,799 filed Mar. 26, 2014, the entire disclosure of which is hereby wholly incorporated by reference.

### STATEMENT RE: FEDERALLY SPONSORED RESEARCH/DEVELOPMENT

Not Applicable

### BACKGROUND

1. Technical Field

The present inventive subject matter relates to methods and systems of using remote mobile devices to monitor user viewing of television broadcasts transmitted to central server and using the data for tracking viewing trends and delivering advertising content to the remote mobile devices.

2. Description of the Related Art

Television viewing has historically been a one-way experience, with viewers observing what broadcasters choose to offer up during a particular time slot. Television advertising is inserted at various points in a television show or sporting event through pre-sold slots that are priced according to expected television ratings during the time slot. With the introduction of reality television, there has been a shift toward interactivity, with viewers voting by telephone or text message that can influence the course of the show and outcome. Viewers that have become immersed in such shows have demonstrated an eagerness to influence a show and a willingness to spend money to do so. For example, in some shows, it has been reported that around twenty five percent (25%) of the votes originated from SMS messaging that typically causes a phone carrier charge to the viewer.

With smartphones, tablets and laptops, it has become a more recent trend for viewers to divide their attention between the traditional television screen and a mobile device screen. Some studies suggest that eighty five percent (85%) of tablet and smartphone operators use their devices while watching television at least once a month and forty percent (40%) do the same on a daily basis (Nielson, December 2012). Also, it is understood that in many instances, in about forty percent (40%) the cases, viewers seek additional information via the second screen on the television show that they are viewing at the time.

Using mobile devices to capture images and transmit information regarding such images are described in U.S. Pat. No. 7,016,532 to Boncyk et al., issued Mar. 21, 2006, and incorporated herein by reference in its entirety, which describes a method and process through which individuals can use their cell phones, PDAs and the like to take digital images of two and three dimensional objects, the image(s) or information derived from the image(s) can be sent to a distal server, and the server can use the transmitted information to identify an object within the image. Having identified the object the server can then provide additional information (telephone number, address, web links, and so forth) back to the individual taking the digital image. That person, in turn, can use the additional information in any suitable manner, such as to execute a purchase, surf the Internet, and so forth. See also the following issued U.S. patents: U.S. Pat. No. 8,224,077 to Boncyk et al., issued Jul. 17, 2012, and incorporated herein by reference in its entirety; U.S. Pat. No. 8,224,078 to Boncyk et al., issued Jul. 17, 2012, and incorporated herein by reference in its entirety; and U.S. Pat. No. 8,218,078 to Boncyk et al., issued Jul. 10, 2012, and incorporated herein by reference in its entirety, each related to use of mobile devices for image capture and using the image information in a useful way.

In addition, US Patent Application Publication No. 2014/0013352 to Shavit, et al, and incorporated herein by reference in its entirety, demonstrates a method and system for detecting signatures of broadcast video and matching signatures for identifying information about the broadcast video.

All publications identified herein are incorporated herein by reference in their entirety reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. The forging description includes information that may be useful in understanding the present inventive subject matter. It is not an admission that any of the information provided herein is prior art or relevant to the present inventive subject matter, or that any publication specifically or implicitly referenced is prior art.

Accordingly, there is a need in the art for a system and method to take advantage of the trend of television viewers that utilize a second screen through a mobile device while also talking advantage of the capability of capturing broadcast data through on board sensors of the mobile devices to provide feedback to broadcasters and advertisers about viewer's activities, and to also take advantage of the feedback information in real time. Various aspects of the present inventive subject matter address this particular need, as will be discussed in more detail below.

### BRIEF SUMMARY

Methods and systems for data session management related to monitoring user activity of remote electronic devices where those users simultaneously view television programs on a second device such as a television screen. Also, there are shown methods and systems that use broadcast information of television or other devices that are picked up by remote device sensors to correlate this user activity with broadcast activity. The data collected from the remote devices, such as smartphones is transmitted to a central storage and server for providing analytical data for use by broadcasters and advertisers to aid in marketing efforts.

The plurality of remote devices, such as mobile devices, include sensors to detect broadcast information from a television or other broadcast device that is in sensor range. An agent on-board the plurality of remote devices uses content recognition technology to recognize the broadcast information. Once recognized, the recognized broadcast data, along with data related to user interaction with the remote device, is transmitted through a network to an audience trends database. The content management server coupled to the audience trends database and a broadcast information database correlates data between the databases and derives content relevant analytics data. The relevant analytics data is provided to subscribers such as advertisers and broadcasters to show viewing trends, and based upon the trend, the subscribers can push advertising or other content to the plurality of remote devices, or to specific devices by a number of means. In addition, the relevant analytics data can be machine monitored such that upon the data meeting certain predetermined values, definitions or criteria that are provided by the subscribers, advertising can be automatically pushed to the plurality of remote devices. The collected content relevant analytics data is presented to subscribers through a graphical user interface that allows advertisers to determine temporal relevance, value and to monetize the information provided by the system and method.

The present inventive subject matter will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an overview of the system of the present inventive subject matter;

FIG. 2 is a flowchart demonstrating a method of session management of data between a content management server and a plurality of interconnected remote devices over network;

FIG. 3 is a flow diagram of an overview of the data session management of the present inventive subject matter;

FIG. 4 is flow diagram of the use of real-time broadcasting data related to user viewers to facilitate analysis of viewing trends and advertising;

FIG. 5 is a graphical display of data related to user viewers of broadcasted shows over given periods of time;

FIG. 6 is a graphical display of data related to user viewers of broadcasted shows over given periods of time;

FIG. 7 a graphical display of data related to the number of user viewers for a number of broadcasted shows;

FIG. 8 is a graphic display of data related to user viewers of broadcasted shows during particular time periods and geographic locations;

FIG. 9 is a flow diagram of the use of real time broadcasting data related to user viewers and implementation of directed advertising; and

FIG. 10 is a diagram showing a method of tracking advertisements airing on television shows using the system and method of the present inventive subject matter.

Common reference numerals are used throughout the drawings and the detailed description to indicate the same elements.

### DETAILED DESCRIPTION

The detailed description set forth below in connection with the appended drawings is intended as a description of certain embodiments of a data session management system and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

It should be noted that while the following description is drawn to a computer/server based data session management system, various alternative configurations are also deemed suitable and may employ various computing devices including servers, interfaces, systems, databases, engines, agents, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). Further, the disclosed technologies can be embodied as a computer program product that includes a non-transitory computer readable medium storing the software instructions that causes a processor to execute the disclosed steps associated with implementations of computer-based algorithms, processes, methods, or other instructions. The software instructions preferably configure the computing device to provide data base collection, server instruction and display of useful information or other functionality as discussed below with respect to the disclosed apparatus. In the various embodiments, the various servers, systems, databases, or interfaces exchange data using standardized protocols or algorithms, possibly based on SMS, MMS, HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document “coupled with” and “coupled to” are also considered to mean “communicatively coupled with” over a network, possibly through one or more intermediary devices.

One should appreciate that the disclosed techniques provide many advantageous technical effects including configuring multiple computing devices to present substantially synchronized digital content concurrently. For example, a person's cell phone can be configured or programmed to present advertising content related to a television show where the advertising content is presented in a browser on the cell phone even when the person is browsing unrelated content.

The focus of the disclosed inventive subject matter is to enable construction or configuration of a computing device system to operate on vast quantities of digital data, beyond the capabilities of a human. Although the digital data represents a vast amount of viewership interaction context data, it should be appreciated that the digital data is a representation of one or more digital models of the user interaction context, not an actual user state. By instantiation of such digital models in the memory of the computing devices, the computing devices are able to manage the digital data or models in a manner that could provide utility to a user of the computing device that the user would lack without such a tool. More specifically, the user interaction context data from hundreds, thousands, or even more than a million viewers can give rise to interesting synchronized content delivery

The remote devices presented herein can be what are typically referred to a mobile devices such as a smart phone, which represents one of many different types of devices that can integrate into the overall environment of the data session management system of the present inventive subject matter. Remote devices, electronic devices and mobile devices can include, for example, smart phones and other wireless telephones, laptops, netbooks, tablet PCs, and other mobile computers, vehicles, sensors (e.g., a camera), media players, personal digital assistants, MP3, augmenting glasses, wearable technology such as glasses with optical head-mounted displays and smart watches or other media players and gaming platforms. Other types of devices can include electronic picture frames, desktop computers, appliances (e.g., STB, kitchen appliances, etc), kiosks, non-mobile sensors, media players, game consoles, televisions, or other types of devices. Preferred devices have a communication link and offer a presentation system (e.g., display, speakers, vibrators, etc.) for presenting data to the user and also preferably include on board sensors such as cameras, audio receivers and/or radio frequency receivers. Any device that is capable of connecting to the internet can operate as a remote device.

Broadcast data can include data from multiple sources or sensors. In the embodiments shown on the remove devices, a sensor (e.g., a camera) collects data from a television or other broadcast device being viewed or listened to by a viewer. Contemplated sensors can include, for example, microphones, magnetometers, accelerometers, biosensors, radio receivers, still and video cameras, weather sensors, optical sensors, or other types of sensors. Furthermore, the types of data collected can cover a wide range of modalities including image data, audio data, haptic data, or other modalities. Even further, additional data can include electronic program guides, weather data, location data, orientation data, movement data, biometrics data, or other types of data.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The inventive subject matter comprises a computer implemented method and system of a mobile marketing platform to assist broadcasters and marketers by allowing numerous television viewers to simultaneously provide viewer feedback to a central server while also providing interactivity to the viewer with synced content, targeted ads, game-like ads and participation by the viewers in social activities in order to change the common viewing experience without the need to change existing infrastructure. The method and system of the present inventive subject matter augments broadcaster advertising content to provide broadcasters and advertisers with tools to increase exposure by extending the broadcasting experience to additional devices, namely second screen devices, such as mobile devices, for example. The method and system enables viewers to discover and interact with related content synced to the viewed show's timeline. Viewers can therefore better engage with their show and areas of interest on the traditional television screen and the more personalize device such as tablets and smartphones. A television show can be augmented with information (facts, data tables, live updates), social media interaction (polls, trivia, social fees, votes, contests), related content (video, audio, ad unit, links) and product and other offers for consumers (purchase, subscribe, vote, acquire related content).

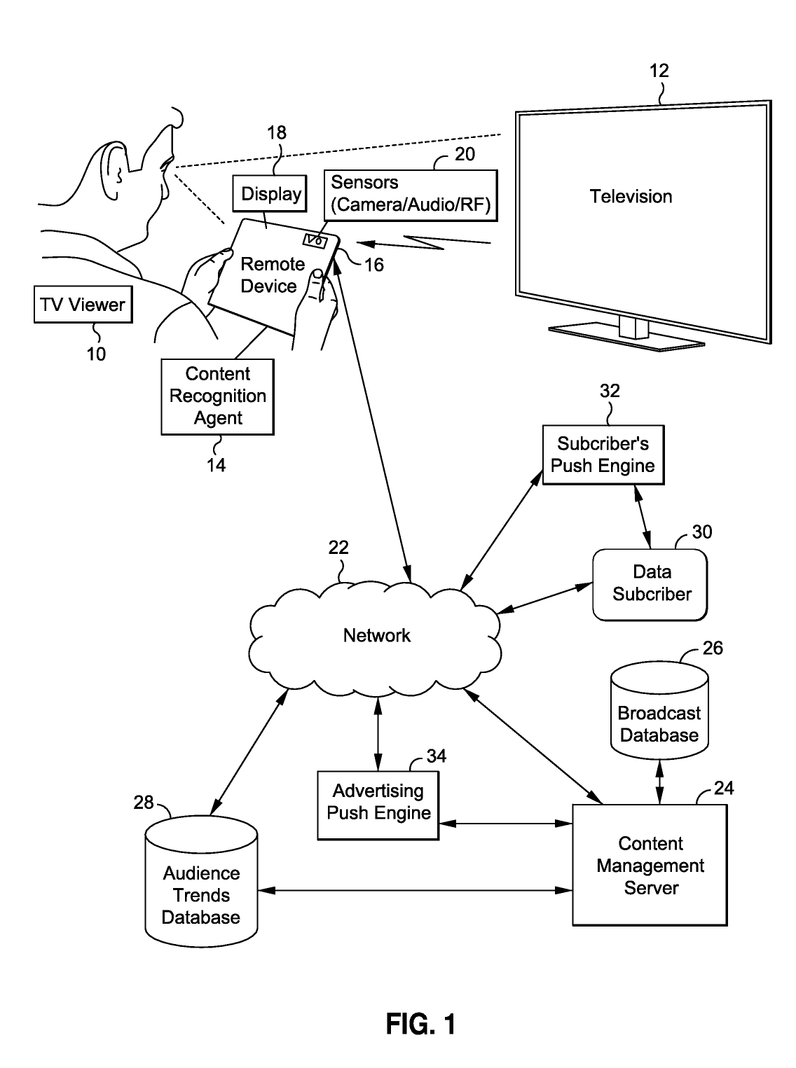

FIG. 1 is a diagram that illustrates an overview of the computer implemented system of the present inventive subject matter that also facilitates execution of the steps a session management of data of the method of the present inventive subject matter. In the system, a television viewer 10 views television programming from a television 12. As is standard, the television 12 may display video or images on a screen or audio through speakers (not shown) and in some cases broadcasts radio frequency (RF) data such as Wi-Fi or Bluetooth®. Television and broadcast device are used interchangeably herein, but a broadcast device can include, without limitation a television, radio, satellite radio or any other audio or video streaming device. A remote device 16 is deployed as a “second screen” device in relative proximity to the viewer 10 and/or the television 12. A content recognition agent 14 is installed on a remote device 16 that may include an application program interface (API) to provide interactivity to the user viewer 10. The television viewer 10 is also a user of the remote device 14 and may be referred to herein as the television viewer, TV viewer, user viewer and/or viewer user or collectively as television viewers, TV viewers, user viewers or viewer users. Also, even though the user viewer 10 may be referred to in the singular it is contemplated by the present inventive subject matter that numerous user viewers 10 will be included in the system of the present inventive subject matter for the collection of data over a number of user viewers 10. The remote device 16 may include a display 18 through which a user viewer 10 receives content from the system and/or is used as a means of interactively engaging with the system of the present inventive subject matter through an API. The agent 14 may be downloaded and installed by the television viewer 10, or the agent 14 may be pre-loaded on the remote device 16 or is otherwise transmitted and installed by a carrier or service. The remote device 16 includes sensors 20 such as a camera, microphone or RF receiver such as Bluetooth®. It is understood that the remote device 16 may comprise a number of electronic devices that use cameras, microphones and/or Bluetooth®, and typically include smartphones, PDAs, tablets and laptops.

The agent 14 utilizes known methods of automatic content recognition (ACR) as described in the background of this document, through use of the sensors 20 of the remote device 16 to sense broadcast information emanating from the television 12, including video, images, audio and/or RF signals of a viewed show. In operation, for proper collection of broadcast information through the sensors 20 of the remote device 16, the remote device 16 must be held or placed in proximity of the television 12 within the range of sensors 20 of the device 16. For video and images that may require line of sight between a sensor 20 camera and the television 12, or within microphone reception distance of sensor 20 microphone or within radio reception range of a broadcasted RF signal from television 12. The television ACR technologies of the agent 14 (voice, image, video, speech, etc.) may work in 2 steps after collecting broadcast information from the remote device 16 sensors 20: in the first step the content is scanned and analyzed by an ACR engine included within the agent 14 that saves the analyzed fingerprints in a central fingerprint repository. In a second step, the agent 14 application scans and analyzes the content and matches the resulted fingerprints (e.g., signatures, descriptors, salient parameters, key frames, etc.) with the central fingerprint repository identify the program being viewed (or previously viewed) and catalogs the time within the show (timestamp). The onboard agent 14 uses ACR that allows user viewers to point their remote device at the screen or to listen to the TV and identify in real time the show being aired and the point in time the viewer is in. This info is then used to retrieve the relevant timeline event from the content management server 24.

In addition to the ACR activity the agent 14 also monitors the user viewer's 10 interaction with the remote device 16 including, but not limited to, GPS data of the remote device 16, the number of user viewer 10 interactions with the remote device 16 during, before and after a recognized broadcast, and the duration of use of the remote device 16 by the viewer user 10 during, before and after a recognized broadcast along with responses to trivia, survey or interactive responses presented to the user viewer 10. Further, to the extent the television 12, or its related components such as a cable box receiver, satellite box receiver or Wi-Fi modem broadcast electronic programming guide (EPG) by RF or other means, the agent may also record such broadcasted data from the EPG. Collectively, the ACR activity of the agent 14, the monitoring of user viewer 10 interactions with the remote device 16, along with EPG data is herein collectively referred to as “user interaction context data”.

A user interaction context can be considered a digital representation of a set of circumstances relating to how a user is interacting with their 2^{nd} screen device (e.g., cell phone, tablet, phablets, gaming device, etc.). An agent disposed on the device can be configured to monitor the user's interaction from number perspectives. In a simple example, the agent could monitor which applications the user has open at a given time. More complex observations are also possible. The agent can also observe or otherwise monitor the user's “click stream” with respect to applications that are currently running. The click stream could include number of interactions per unit time, type of interactions (e.g., clicking, scrolling, typing, etc.), duration spent with an application (e.g., time spent on web page, etc.), or other type of interaction. Further, the agent could also monitor the ambient environmental data around the user to gather information about the user's environment. Such ambient environmental data can be obtained via the device's sensors.

The user interaction context can be compiled into a consumable package via one or more techniques. In some embodiments, the observed interactions could be compiled into a serialized format for consumption by the remote servers, possibly using a JSON, XML, or YAML protocol. In such a case the remote server could analyze the raw data to make a determination of the final user interaction context. In other embodiments, the agent on the device could consult an ontological lookup table to determine a context (e.g., “playing a game”, “browsing the web”, “shopping for a car”, “researching current broadcasts”, “UNKONWN”, etc.) based on the raw data. In this case, the agent could provide a context identifier (e.g., GUID, UUID, etc.) that corresponds to the derived context to the remote server for further use.

In addition to collection the user interaction context data, the agent 14 sits on the remote device and acts as a software device application for interaction with the user viewer 10. In this regard, the agent 14 can receive messages and content from remote servers that are part of the system of the present inventive subject matter and display the messages or content to the user viewer 10 on the remote device 16. The messaging and content received by the agent 14 in a number of ways and may be displayed via browser content, banner advertisements and SMS messaging. Also content can be transmitted to the remote device 16 in the form of a survey, trivia question(s) or voting request. Further, content may be delivered to the device 16 via a third party system, such as a banner advertisement appearing within a browser. The agent 14 is further capable of transmitting the user interaction context data and other information to one or more remote servers and/or databases within the system of the present inventive subject matter over a network which is described in more detail below. The agent 14 can also store the information locally on the remote device 14.

In operation the agent 14 uploads user interaction context data from the remote device 16 or a plurality of like remote devices 16 a network 22 to a content management server 24. The content management server 24 is coupled to the network 22 and comprises a computing device having a processor configured to execute stored software instructions. The communication of the data through the network connection 22 is accomplished through known methods and systems and data exchanges preferably are conducted over a packet-switched network, the Internet, LAN, WAN, VPN, PAN, or other type of packet switched network or aggregates of such types of networks. The content management server 24 may be coupled to a broadcast database 26. The broadcast database 26 stores information about current and past programming from broadcasters. The information in the broadcast database 26 can by populated by subscriber information from broadcasters or from publicly available sources. For example, the broadcast database 26 can include information that is found in electronic programming guides. The interaction context data received by the content management server 24 is processed by the server 24 wherein the interaction context data is correlated with the broadcast data from the broadcast database to derive content relevant analytics data. The content relevant analytics data can be saved into an audience trends database 28. A data subscriber 30 through a network 22 can access the content relevant analytics data stored in the audience trends database or through the content management server 24 via known mechanisms such as graphical user interfaces or other similar mechanisms. It is contemplated by the method and system of the present inventive subject matter that the user, acting upon content relevant analytics data, could create content to be sent through a subscriber's push engine 32. For example, a broadcaster data subscriber 32 broadcasts a sporting event in which user viewers 10 are engaged. During the sporting event, the broadcaster accesses the data from the audience trends database to 28 which demonstrates, in real time, that users are leaving the broadcast due to a lopsided score (as detected by the plurality of remote devices 16 and communicated through the network 22 to the content management server 24). In this hypothetical, in the last minutes of the game or match, the losing team comes from behind to even the score. The broadcaster wishing to alert its viewing audience to return the broadcast deploys its own advertising push engine 32, or a push engine contracted through a third party, to send banner adds through popular search engines, news sites or other popular locations on the web to alert user viewers 10 within the system or potential viewers outside the system of the close score and attempt to increase viewership. Even though content would be delivered to viewers and potential viewers outside the system it is contemplated that the user viewers 10 would provide a representative sampling of overall viewership. In addition, in the same hypothetical, the subscriber 32 could also request from the content management server 24 through the network 22, that the advertising push engine coupled to the server 24 send direct messages to the plurality of remote devices 16 through the network 22. In this scenario the agent 14 could provide real-time messaging to the remote devices 16 informing the user viewers 10 of the close score and seeking their return to increase viewership. In this same hypotheticals, predetermined values could be set within the content management server 24 by the data subscriber 30 that when viewership falls below a threshold (or reaches a threshold or peaks) that an automated message, survey or trivia question could be sent through the advertising push engine 34 to the remote devices to attempt to re-peak interest in the broadcast. Likewise, for data subscribers 30 that employ push engines outside of the system, predetermined values could be set within the content management server 24 by the data subscriber 30 that when viewership falls below a threshold (or reaches a threshold or peaks) an alert can be sent to the data subscriber 30 or its designated recipient to employ subscriber's push engine 32.

By analyzing the interaction context data of the remote devices of the 16 the system and method of the present inventive subject matter allows for broadcasters to provide targeted advertising to specific viewers that are interested in a particular show or advertisement from. Relevant advertising can be pushed by the advertising push engine 34 out to the plurality of remote devices 16, or specific targeted devices 16. Although the push engine 34 is referenced as an advertising push engine it is understood that such push engine can deliver more than advertising, but can also deliver other content, surveys, trivia questions, video content, images and other content useful the subscriber. Also, although the push engine 34 is shown as a separate component, it is understood that push engine 32 may be a component of the content management server 24 or a subroutine within software running on the content management server 24. The push engine 34 allows subscribers to provide specific pricing to targeted user viewers 10. The system with analysis of the uploaded data from the remote devices 16 enables the subscriber to identify and provide brands a list of specific consumers who showed interest in the advertised product/brand/service. Similarly, brands can create direct customer relationships and provide interactive advertisement and to receive real-time feed-viewers and track trends on-line through a subscriber 32 interface on the content management server 24.

For example, during an auto commercial the agent 14 at the prompting of a subscriber 32 either in real time or through a pre-set question, presents the device 16 a question about the product: “In what year was ‘x model’ first released? The first five hundred viewers to answer correctly before the end of the commercials break could receive a pass to test drive the new x model with a professional driver on a racing track. As may be evident, the viewers who attempt to answer example trivia question on the device 16 are more likely to be interested in the same or similar class car and since the direct connection has been made, the brand can now identify the viewer for targeted “one-on-one” marketing. These types of interactions, including game-like interactions heightens interest and draws the viewer into identifying themselves through interaction.

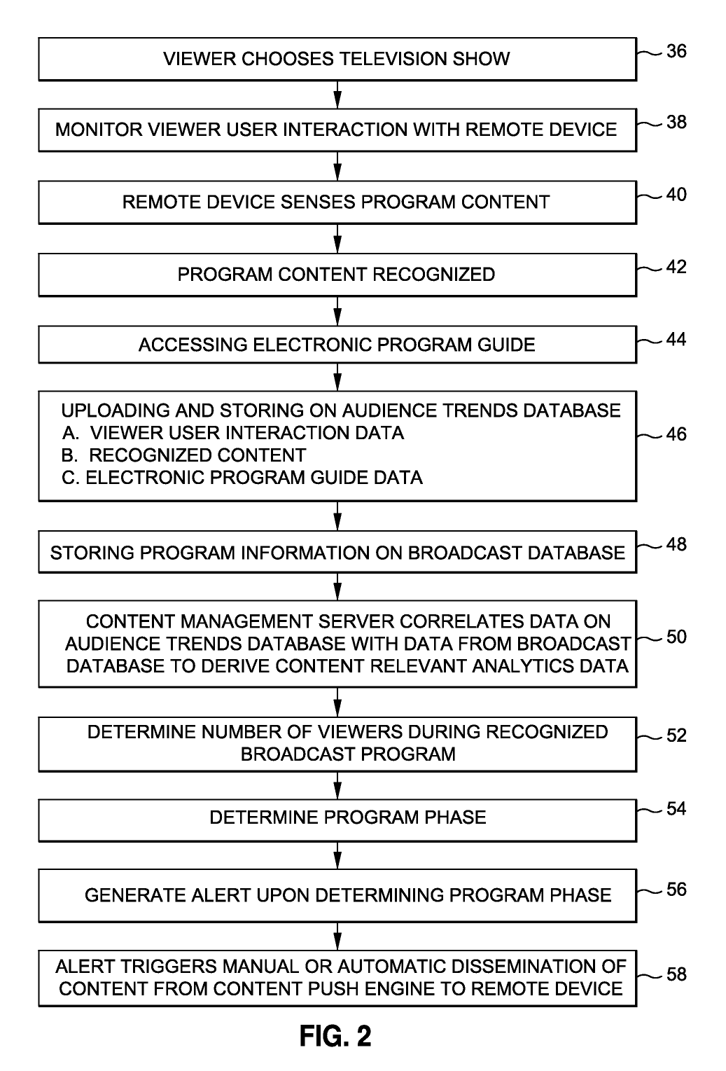

Referring particularly to FIG. 2, there is shown a flow chart illustration of the method discussed herein, with reference to system components shown in FIG. 1. The steps provided are not required to be completed in sequence. An interaction starts with a user viewer 10 selecting a television show or program in step 36. The user viewer 10 places the remote device 16 or “second screen” in proximity to the user viewer's 10 reach, and in range of one or more sensors 20 of the device 16. In step 38 the on-board agent 14 monitors the user viewer 10 interaction with the remote device 16. Such interaction can include the number of times the user viewer 10 touches the screen on the device 16, the duration of such screen touches, when screen touches happen during the programming (correlated to a broadcast segment), when a user viewer starts or starts or stops watching a program, the duration of the time a user viewer 10 watches a program, GPS information related to the device 16, and interactive responses or ignored interactive requests, among other activity.

In step 40 the device, through the sensors 20 senses and/or records broadcast content in the form of video image data, picture image data, audio data or RF data. The agent 14 adapted with ACR technology recognizes the program content in step 42. In step 44, the agent 14 can access available EPG information and index the information with the sensed content. The collective data monitored, sensed and accessed is then uploaded in step 46 through a network 22 to a content management server 24. The uploaded data includes viewer interaction data, recognized broadcast content and EPG data.

In step 48, broadcast information is provided by system subscribers or by publicly available information and stored in a broadcast database 26. The broadcast information can include data similar or the same as EPG data, or can include more detailed information about a broadcast such as when advertisements are aired during a program. The commercials may be time stamped to be correlated to data received from the plurality of remote devices 16. In step 50 the content management server 24 executes stored software instructions to correlate data uploaded from the plurality of remote devices 16 to the broadcast data stored on the broadcast database 26 to derive content relevant analytics data and is populated onto the audience trends database 28. The content relevant analytics data is used in step 52 to determine the number of user viewers 10 of a broadcast program for a particular period of time. Using the same data, in step determining a program phase. As used herein a program phase can mean a number of predetermined criteria set by the subscriber 32 or set in the content management server 24. For example a program phase can mean a threshold amount of viewers of a given period of time, a ramp down phase which is a decrease in a predetermined number or percentage of user viewers 10, a ramp-up phase which is an increase in a predetermined number or percentage of user viewers 10, a peak phase which is a determination of the peak of programming based upon the largest number of user viewers 10, a presentation phase which is based upon a time duration during a broadcast or advertisement, among others. In step 56 when a phase is determined in step 54, an alert is generated. The generated alert of 56 can case a trigger in step which causes an automatic generation of content that is broadcast through the network 22 to the displays 18 of the devices 16. In addition, an alert can be communicated to a subscriber 30, who can decide, depending on the nature of the alert, decide in real time the content of a message to be communicated to one or more remote devices 16.

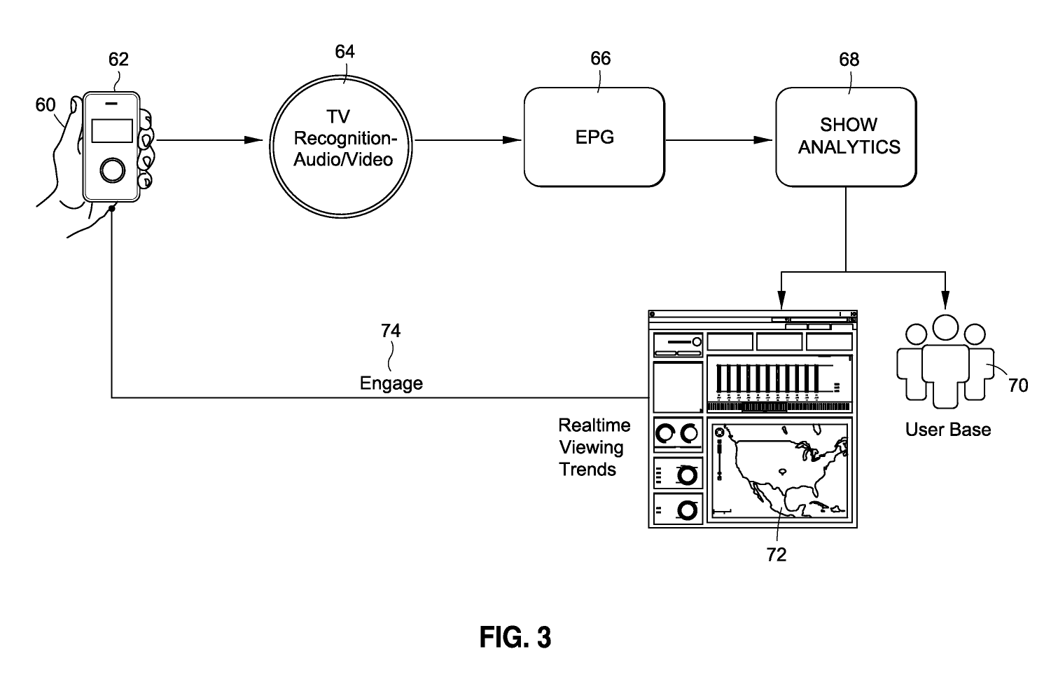

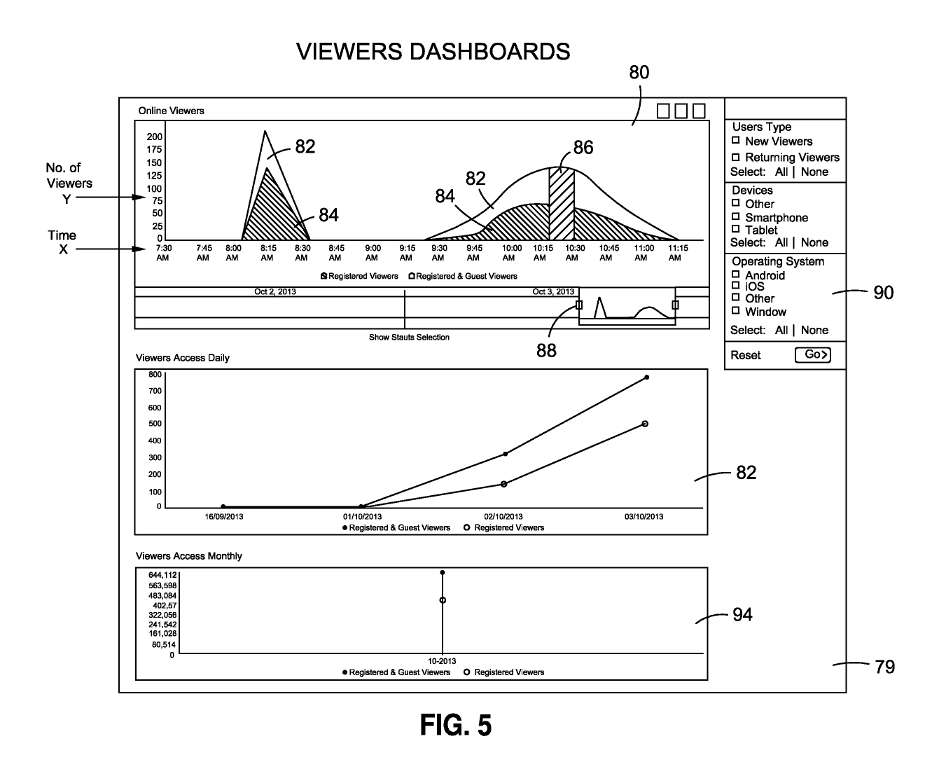

FIG. 3 shows an illustration of the basic flow of the system and method of the present inventive subject matter. A user viewer 60 directs a remote device 62 to direct sensors on board the device 62 to a television broadcast. The device 62 is coupled to a network through cellular, Wi-Fi or other known network systems. Although this description refers to a television broadcast, the broadcast could be over any relevant medium such as radio or webcast. An agent software application on board said device 62 uses the device 62 sensors to provides content recognition 64 which recognizes and identifies a particular program. EPG 66 information is retrieved related to the broadcast. The EPG information 66 can be accessed from the local television or television components, or can be accessed from remote databases coupled to the network. Content recognition 64 and EPG 66 are transmitted across a network to be stored in a show analytics database 68. Broadcasters and advertisers of a user base 70 can access the database 68 in real time through a real-time dashboard 72, for which exemplary screenshots are shown in FIGS. 5-8 described in more detail below. Based upon the data presented to the user base 70 through the interface 72, the user base broadcasters and advertisers can decide how to engage 74 user viewers. Engagement can include a number of types of content that are pushed to the remote devices 62 in the form of content in the form of directed advertisements, video or image content, SMS messaging, interactive trivia questions, coupons, games and votes.

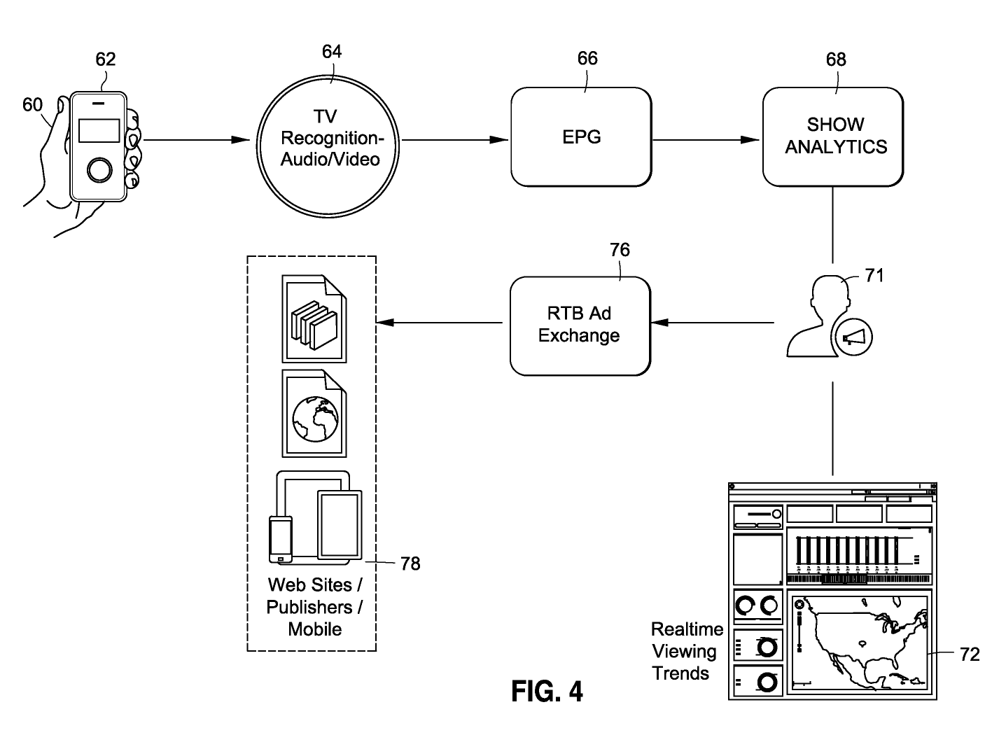

Referring particularly to FIG. 4, a flow diagram illustration provide more detailed flow of FIG. 3. A user viewer 60 directs a remote device 62 to direct sensors on board the device 62 to a television broadcast. The device 62 is coupled to a network. An agent software application on board said device 62 uses the device 62 sensors to provides content recognition 64 which recognizes and identifies a particular program. EPG 66 information is retrieved related to the broadcast. Content recognition 64 and EPG 66 are transmitted across a network to be stored in a show analytics database 68. Broadcasters 71 can access the database 68 in real time through a real-time dashboard 72. Using a graphic user interface (GUI) the broadcasters 71 can identify a scenario where viewers are leaving a show. The broadcast can then implement a real time broadcasting (RTB) campaign 76 on the screen of remote device 62 to entice user viewers 60 to return to a broadcast. For example, during a reality show the broadcaster can create an ad, which can be displayed as banner ads or other available content space on popular search engines, news websites, content aggregators, social media websites, message boards, blogs or message feeds informing viewers that a big event on the show is imminent within in the next few minutes to entice a return to the television broadcast instead of the 2nd screen remote device 62. This process can be done automatically based on predefined templates, values or parameters. As such the RTB campaign is sent to the various websites, publishers and devices 78. Such an approach is considered advantageous because it allows subscribers to subtly nudge viewers back toward the content

The GUI viewer dashboard as shown in FIG. 5 is useful in describing the RTB campaign of FIG. 4. In FIG. 5 there is shown a screen shot 79 of a GUI that provides the subscriber or user base with real-time information. In this example, the top graphic 80 demonstrates the number of user viewers plotted on the y-axis against the time of day on the x-axis. The unshaded regions 82 may represent guest users and the shaded area 84 represents registered users. In viewing the data in real time, a subscriber (broadcaster) can set a predetermined RTB campaign during a peak time in the show, represented by the shaded region. As such, a broadcaster being alerted to the peak 86 could manually initiate a campaign, or have the campaign pre-set to automatically deploy upon the triggering event such as a peak 86. A slide bar graphic 88 can be provided to find and extend periods of interest in the top display 80. Filter switches 90 are provided for filtering the results. For example a subscriber could differentiate between the following: user types, such as new or returning viewers; device types such as tablets, smartphones or other; operating systems such as android, iOS, windows or other. Time period for larger views such as daily viewer access 92 and monthly viewer access 94. As such, the subscribers could determine monetary value of identified phases to create engagement points for the viewers. While the example above provides peak phases, phases could be identified by a number of salient parameters that can be measured empirically. The parameters can include duration, expected slope, observed slope, real-time number of viewers, real-time change (dx/dt) in viewers, type of engagements (e.g., passive watching, number of second screen interactions, etc.). It should be appreciated that the rate of change of values could also include higher order derivatives beyond just a rate, which provides the disclose system greater latitude in predicting the nature of ramp up or ramp down phase values. The user viewers can also be characterized by the nature of the user viewer for example, new viewers per unit time entering the phase, viewers per unit time leaving the phase, viewer duration, viewer number of interaction with the phase, viewer number of interaction during the phase, previously known viewers not yet engaged and/or demographics of user viewer. It is understood that a viewer might be watching a different show or engaging with different media, for example engaging with a computer. Through characterization of the viewers by device and phases (especially the ramp up and ramp down phases), value can be created for subscribers such as advertisers, broadcasters, content providers, producers and third parties. As a result the subscribers can tailor directed messages according the nature of the phases (such as ramp up or ramp down) based on the phase parameters. For example the subscribers can tailor their messages to subtly “nudge” viewers to stay engaged during ramp up or ramp down phase. Also, subscribers can provide create highly personalized content based on the nature of the phase such as the ramp up phase or ramp down phase. Subscribers can empirically measure the impact of their engagement with the viewership per phase or as a result of more dispersed real-time advertising. Through social sharing or other techniques, the subscribers through the graphical interface can measure it is advantageous to alter the phase parameters such as during ramp up and ramp down, (e.g., increase the duration, increase the number of viewers, etc.). Subscribers have the ability to monitor their own content relative to competing content. As such with observation the parameters of the phases can then be used for monetization. In this regard, advertisers can gain, or bid on exclusivity with respect the aspects of the phases, but time slice, by number of viewers in slice that have met desired criteria. Advertisers could also pay for the nature of the phase; when the ramp up slope (dx/dt or other higher order derivatives begins increasing quickly, then it triggers a specific message from a paying advertisers. Target content from the advertising push engine 32 or 32 can be presented at different times than during the show, such as preceding or trailing a show.

Although FIG. 5 presents a possible distribution of viewership numbers as a function of time in the form of a Gaussian distribution, it is possible that each individual show could comprise its own characteristics viewership distribute as a function of time. Further, each part of the distribution, especially the ramp up phase and ramp down phase, could be distinctive. Each part of the distribution can be characterized empirically through direct observation by the system to determine the nature of the phase's distributions. Example parameters that could be used to characterize the distributions could include a type of distribution (e.g., Gaussian, Poisson, binomial, etc.), a slope, a rate of change, an average, a time coordinate (e.g., start, stop, middle, etc.), a width, or other parameters. Such parameters can then be used to establish expected base-lines for the target show. Should the actual viewership deviate from the base-line, the system can notify relative subscribers of the deviation and provide opportunities for the subscribers to provide their content to the 2^{nd} screen viewers. For example, a subscriber might purchase exclusive rights to presenting their advertising content to 2^{nd} screen users only when the ramp up phase has a rate of change that is between 1.5 and 2.0 of the expected ramp up rate of change. Thus, the disclosed system allows for devices to characterize viewership parameters that can then be individually managed as data objects and monetized.

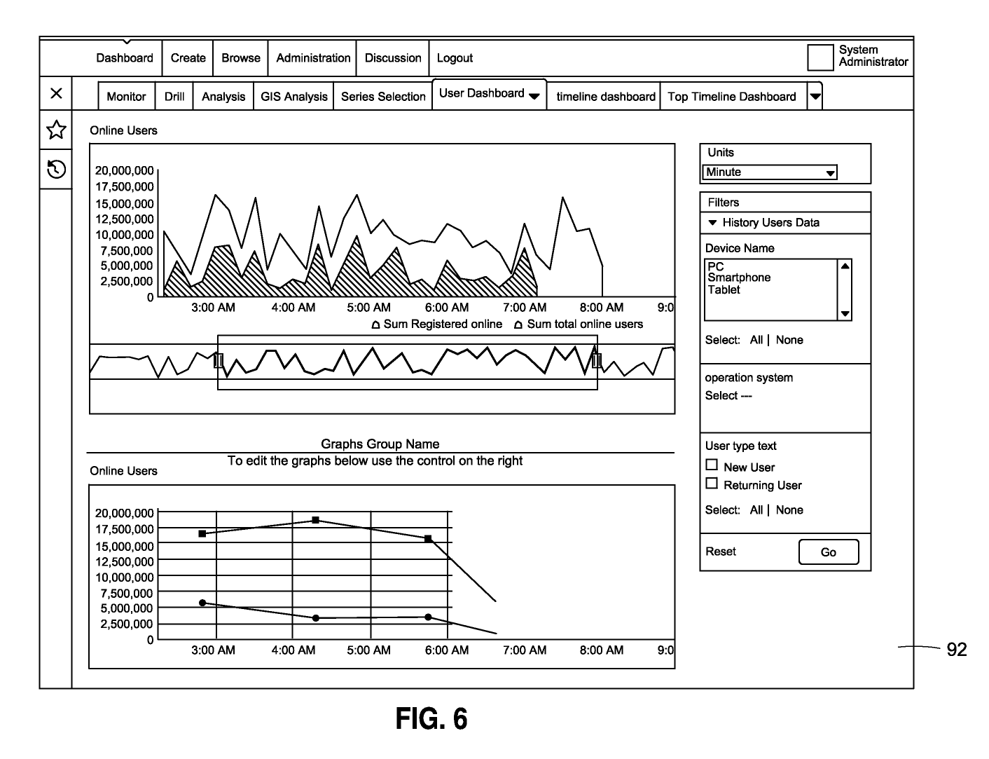

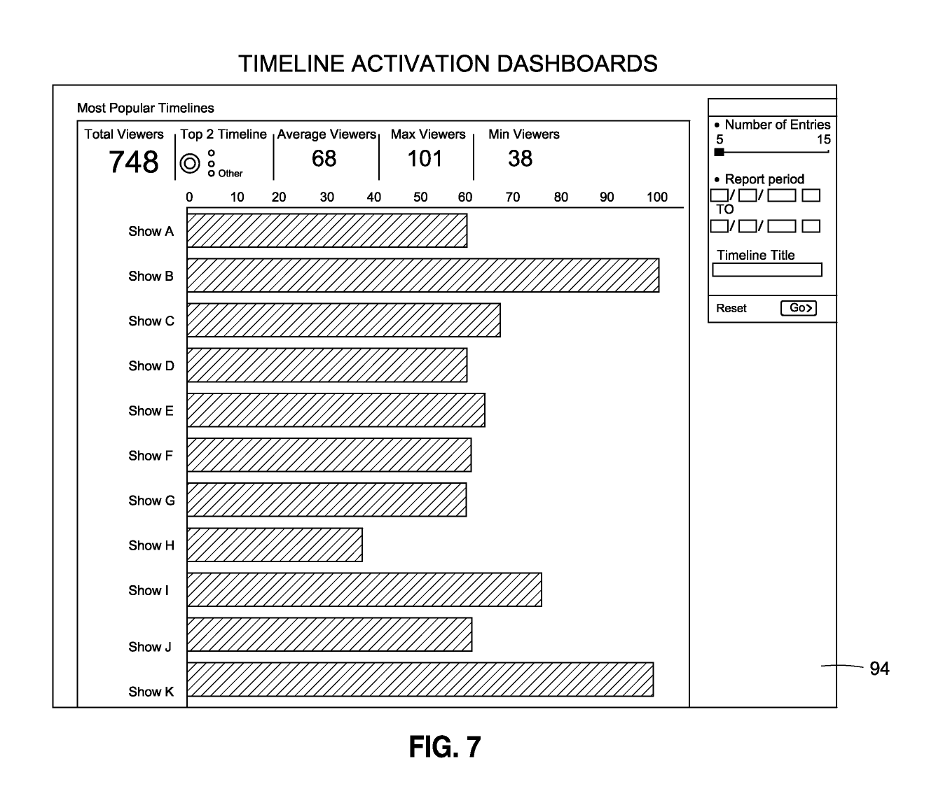

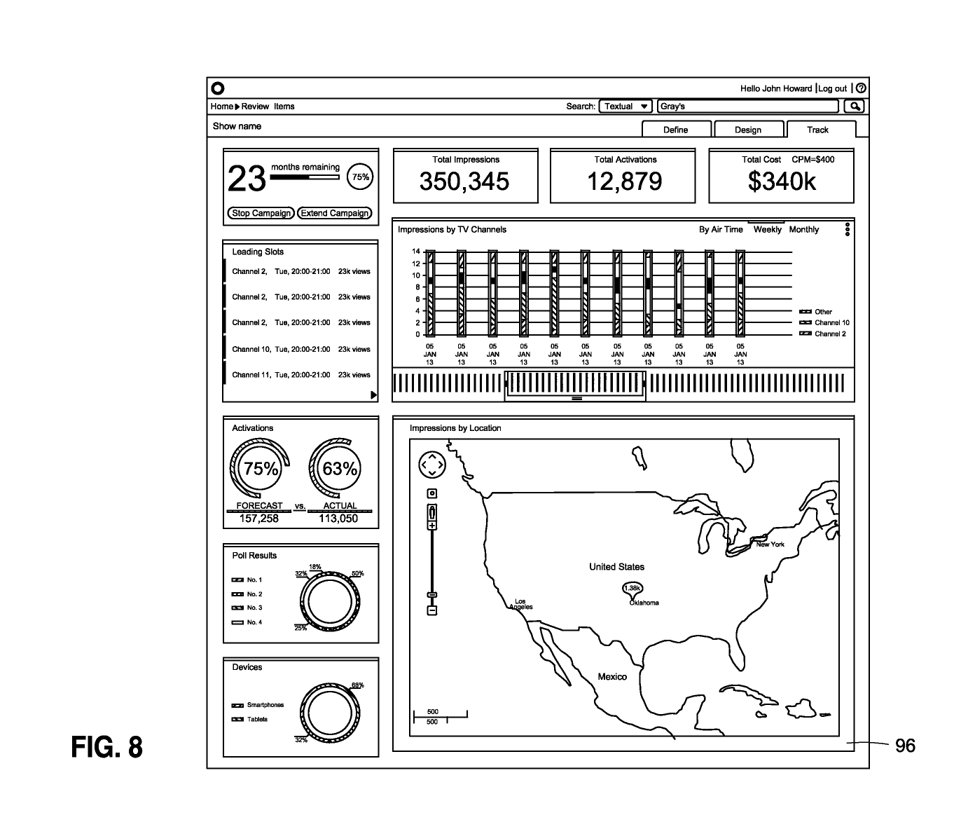

Referring to FIG. 6, another dashboard screenshot 92 is provided with a slightly different graphical interface than FIG. 5, but provides similar information to the subscriber. FIG. 7 provides a screenshot 94 for the GUI showing a timeline activation for a comparison of a plurality of shows indicating the number of user viewers and activation per timeline. The timeline is a sequence of events for a specific show. The graph of FIG. 7 shows a comparison of the popularity of the timelines. Advertisers can use the information for determining advertising values for a particular show. FIG. 8 provides a further screenshot 96 which provides a further example of the use of the GUI used in the system and method of the present inventive subject matter. For a particular advertising or voting campaign, the subscribers can track costs, number of participants, views, activations and numbers correlated to geographic location. The geographic location can be gathered from GPS information of the remote devices uploaded to the audience trends database. Location can also be tracked by using IP to the level of the city or town of the remote device or can be input by the device user manually. Also poll results can be tracked and displayed shown with forecasts.

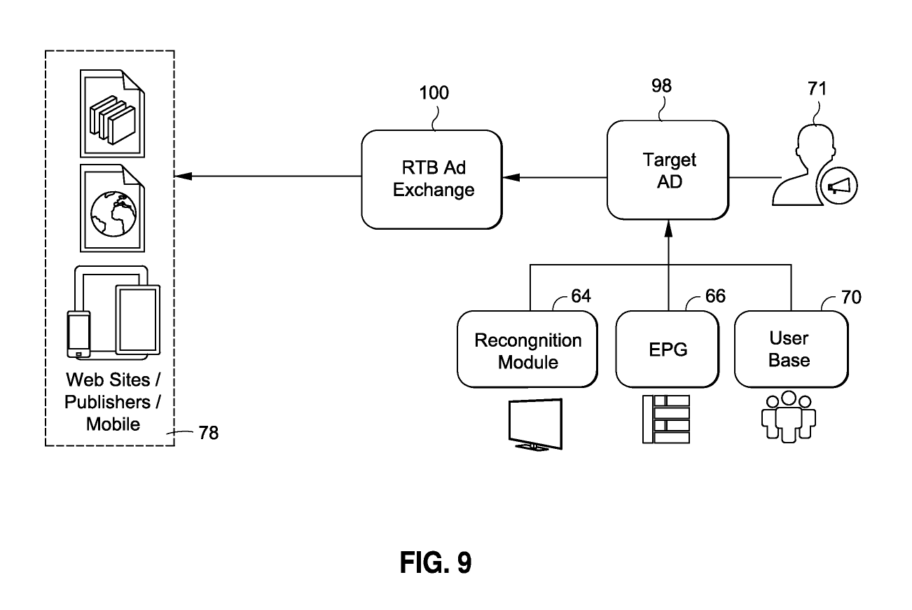

FIG. 9 is a graphical flow of the use of a target advertisement in the context of the system and method of the present inventive subject matter. The user base 70 included the uploaded date from the remote devices 16. EPG 66 information is retrieved related to the broadcast identified in the user base 70. The content recognition 64 and EPG 66 are transmitted across a network to be correlated to the user base 70. Broadcasters 71 can select targeted advertisements directed to particular users in the user base 70 and supplied to the real time broadcast ad exchange 100 that can deliver content in the form of directed advertisements, video or image content, SMS messaging, interactive trivia questions, coupons, games and votes specifically tailored to the selected user from the user base 70. Also, the ad exchange 100 can be left open for bidding by the various advertisers or broadcasters to increase the value of the advertising slot.

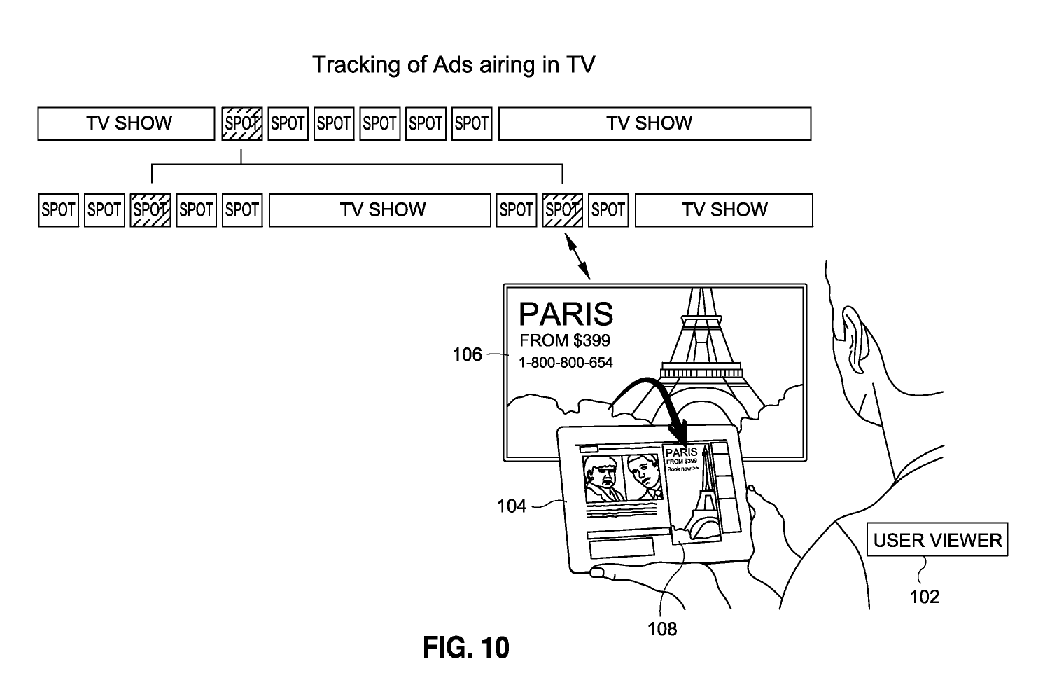

FIG. 10 is a graphical illustration a real-time tracking of advertisements during a broadcast or over a plurality of channels or broadcast networks. The method and system of the present inventive subject matter can be used by the subscribers (broadcasters and advertisers) to track advertisements to identify when the commercial was aired and on which broadcast. For example an advertiser can track paid for advertising in specific time slots, and the advertiser can verify that the advertisement was delivered as planned. Also, subscribers can be (a) notified in real-time when a particular advertisement airs; (b) identify ads currently playing; (c) when commercials aired on previous breaks; and (d) verifying in real-time broadcast time and position in break. The information can be provided to the subscriber through the GUI. The illustration also demonstrates that pushed content through the system and method of the present disclosure can match the broadcasted content on television 106 with a banner ad or other interface on the display 108 of the remote device 104.

The system and method of the present inventive subject matter enables viewers to discover and interact with related content on their remote devices that is synced to the show they are viewing, in real time, while they are watching it. Viewer users can receive targeted offers on products and merchandize, participate in interactive games such as polls and trivia, and become more engaged with the show they are viewing by getting fun facts and stories related to the show, its actors, and the content being aired. This experience occurs in the viewer's client application on his remote mobile device, e.g. a smartphone or tablet, powered by an agent that stores the experiences and orchestrates them to the viewer's application. The system and method allows content producers, television networks, advertisers and brands to create better, more meaningful interactions with their viewers. Unlike the traditional television broadcasting service that does not differentiate between one household to another, or between a certain viewer to another, engaging TV viewers with their mobile devices in content related to what's being aired, enables brands and broadcasters to develop a personal relationship with the viewers, by providing them relevant information and engaging the user viewers in activities before, during and after a show. This relationship can help create viewers' segments and target specific viewers' groups, thus increasing advertising revenues

The system and method of the present inventive subject matter also includes a subscriber interface (portions of which have been discussed in relation to FIG. 5-8) that includes a management tool to create an advertising campaign and monitor its progress. Creating a new campaign is implemented through a web-based graphical user interface (GUI) with the subscriber enter in simple parameters such as the campaign title, duration and selecting the interactive the engagement requested, for example a poll or trivia. After submitting and entering the interactive content, the marketer can go into a designated location within the GUI and can control the styling of the campaign page using a WYSIWYG interface and a mockup preview of the campaign page. The mockup preview allows the marketer to test the poll or trivia, on-screen, prior to publishing the campaign. Controlling the design of the campaign page is simple and intuitive, using a color picker for each element on the screen, and the ability to paste in exact color values, for those brands who wish to adhere to exact brand guidelines. The overall look and feel of the submitted page is controlled by layers of design elements, for example, a background a solid color can be provided, above it an image (that can be semi or full transparent at parts) is layered over, and above it the elements of the page. A logo may be conspicuously located at the top right corner of the screen, and can be replaced with the marketed brand's logo. The tool is equipped with its own two default base schemes, accompanied with all the visual files that can be downloaded, so the campaign's designer will be able to produce similar-size images that match the brand's voice and theme.

The aforementioned GUI management also provides dashboard interfaces with online data on the number of responses for a campaign, and their distribution among consumers. It includes data on the how long the campaign has been running, the number of impressions and the estimated response rate derived from them both. All this information is presented in an up-to-date, simple format for marketers, and compared against the marketer's forecast prior to launching the campaign.

The subscriber interface is aimed for producers and content editors of the broadcaster. They can use the system's GUI to create a timeline, which may be a collection of events, for a particular program or show. The events can be either informational, such as a story or a fun fact, or they can be interactive, such as polls and trivia, or promotional, such as related content (e.g. an offer on a certain knife promoted during a cooking show). The timeline is then presented to the viewers who use the agent client application on their mobile device. The process can start with timeline creation that can be done with the subscriber interfaces GUI in the form of a production tool or timeline editor that integrate with the system and method of the present inventive subject matter. Below are examples of the types of events to be used in the method and system:

Poll.

A poll has a question and a set of two or more answers. Typically there is no correct answer to a poll. In addition to defining the question and answers, the producer can control the ‘Thank you’ message that is presented to the viewer upon voting for the poll and the number of times a viewer is allowed to place his vote. The poll contains a start date and duration parameters that define when voting is allowed on the poll. A poll can be free or contain a price that denotes how much it costs to place one vote. A poll is an interactive event that enables the content producer to ask viewers their opinion about a defined subject in a form of a question and answers. The viewer will be presented with a question and will be asked to choose one answer. Typically there is no right answer. For example, “vote for your winner for the reality TV talent show” or “who do you think will win the elections?” These interactive polls can be used as an alternative mechanism for SMS voting that can be monetized.

Trivia.

A trivia event acts in the same way a poll does, except for a trivia a correct answer must be defined. A trivia question is an interactive event that enables content producer to ask viewers a question about a specific subject in a form of a question with a few possible answers. Typically there is one right answer. The viewer will be presented with a question and will be asked to choose one answer. For example a trivia question testing viewers' knowledge about a show. Answering the right answer may earn the viewer a prize. Example: While watching an professional basketball, broadcasted live from a particular city, viewers can be asked to answer how many champion rings a popular home town player has: 2, 4, 5 or 7. The first 10 viewers to answer correctly will win 2 court seat tickets (each) to the next home game.

Poll Results.

A poll results event is the results of a specific poll event, including number or/and percentage of voters for each response.

Trivia Results.

A trivia results acts in the same way a trivia does, except the correct answer is also returned.

Story.

A story is a longer text segment typically accompanied with images that allows the producer to post content and information related to the show.

Fun fact.

A fun fact is a shorter text segment accompanied by typically one visual that allows the producer to post fact content.

Games: A game represents content that can interact with the synchronized content. For example, a user could play a browser-based game while also watching a television program. Characters from the television program could be inserted into the game. Additionally, product placement or banner ads could be integrated into the game. In such an embodiment, the game could comprise an synchronized content API through which a push server could provide content. In other embodiments, the game can be designed to consume such an API provided by the remote server.

Related Content.

A promotional offering for a product related to the show being aired. Related content is used to monetize the user viewer's experience and offer the user viewer content related to what was watched while the user viewer was watching it. For example, while watching a music concert, the broadcaster can offer the viewer to buy the concert sound track, a biography book on one of the musicians in the performing band, play a video game associated with the performing band or buy the concert DVD. As part of the system preparation process, the catalog owner/provider provides a file with his catalog of related content items into a designated folder using the GUI. The system ensures that the ingestion process initiates and that all valid products are ingested properly and become available for consumption. Once the related content catalog ingestion is complete, the content producer can assign the related to a specific timeline cue as part of a timeline. The association does not require creation of an explicit link between specific related content item and a timeline; instead the content producer simply enters a list of key words that describe the related content. Afterward when the related content is presented to the viewer within the client, the system selects the best suited related content by applying a recommendation-like algorithm based on the provided keywords and personalized based on viewer's profile context (e.g. language, location, age, purchase history etc.). The user viewer can view the details of the related content offer and proceed to purchase the item. Also events can be added during a particular broadcast to enable viewers interact and influence the outcome of the show. The user can vote in a reality show for a winner, or the viewer user can provide “orders” to the show actors through the remote device to act a certain way, for instance, the viewer user can direct an actor facing two doors to either open the door on the left or the right.

The interactive system and method of the present inventive subject matter features a reference client in the form of a timeline filmstrip which advances with the show and presents the incoming show cues. The filmstrip allows navigating back to past events and reactivating them. Using the filmstrip Play/Pause button on the filmstrip, the played events can be paused so that while synchronization with the show continues the viewer can examine a single event.

For interactive events such as polls and trivia, a management tool is available as part of the method and system. A polls & trivia management tool allows the producer to review the details and the results of polls and trivia created, including number of voters for each response, number of total voters, the price per poll and the revenue from it. The polls and trivia tool enables producers and broadcasters to follow up on polls and trivia they have published to viewers' clients. It contains aggregated data on viewers' votes, with a graphical display of the distribution of votes.

The campaigns management of the present inventive subject matter provides a dashboard with online data on the number of responses for a campaign, and their distribution among consumers. It includes data on the how long the campaign has been running, the number of impressions and the estimated response rate derived from them both. All this information is presented in an up-to-date, simple format for marketers, and compared against the marketer's forecast prior to launching the campaign, including the ability to data mine to explore patterns in specific time frames.

The system and method of the present inventive subject matter allows the user viewer to self-register to the service by clicking the ‘Create new account’ link on a login screen. The viewer is then prompted to input an email address and desired password. The user viewer account is activated only after the user viewer validates the email address, by clicking on unique, time limited link sent to the user viewer's specified email. The system and method also supports login via popular social media websites, where the user viewer authenticates via the user viewer's social media account. The method and system of the present inventive subject matter then uses the public profile information (of the social media account) as part of the viewer's profile. The collected information can be used to further enhance the viewer's experience. The system and method will also attempt linking the social media account with the user viewer's account in order to collect as much information as possible on the user viewer. In addition, the system and method of uses known secure authentication standards on all exposed interfaces in order to supply an integrated secure access methodology. The authentication infrastructure of the system and method of the present inventive subject matter allows defining the software clients accessing the system, client access permission for each of the system Application Programing Interfaces (APIs), and the user roles using the APIs The system supports multiple levels of API access, from completely open to everyone to an API requires admin user login.

The system and method of the present inventive subject matter provides GUI dashboards for user viewers' access to the system, selection of specific timeline by viewer and voting related data collection. In general, the system dashboards rely on internal data collection process that is executed as part of each component in the system. This infrastructure ensures that all actions and API calls are recorded in the system and are aggregated thru a set of dashboards available to the subscribers such as broadcasters or producers. The type of records collected during operation of system actions and API calls as part of the execution of the business flows include timeline activations (discovery), purchase of related content, payments for votes, votes for poll/trivia, viewer logs/access to the system, auditing, content management operations, etc.

A user viewers dashboard is provide that enables subscribers such as producers/broadcasters with an on-line and aggregated view of the user viewers who accessed the service. Subscribers will be able to view at any given moment in time the number of viewers that are using their client, how many of them are registered to the service vs. how many are only guests. Furthermore, the dashboards contain aggregated information on a daily and monthly basis. The aggregated numbers can be further data mine to break viewers by device type as well as to understand how many of them are returning viewers and how many of them have are recent joiners.

A timelines activations dashboard is provided with enables subscribers such as producers or broadcasters with a 24 hours view of the most popular shows amongst the user viewers, based on the corresponding timelines requests. Subscribers such as producers or broadcasters that have a special interest in a specific timeline can further data mine to view a detailed analysis of the requests for that timeline along the time scale. Furthermore, subscribers such as producers or broadcasters that are interested in finding out a timeline's performance during a specific time frame (in case it's not one of the top timelines during the last 24 hours), can search a timeline by its title or apply a search based on the timeframe during which the show was aired in the past.

The advantages of the system and method of the present inventive subject matter includes the leveraging of user viewers' engagement related to certain programs to generate new revenue streams by monetizing real-time social engagements on large scales. For example, monetizing real time voting for polls, trivia, contests and more are enabled. A pay-per-vote model is available, in which the user viewer is presented with a voting option, where he cannot vote until he pays via a payment system (PayPal®, credit card, carrier billing etc.). When the user viewer clicks pay, he's redirected to the payment provider, enters credentials, confirms the payment, then redirected back to the agent application on the remote device, where the user viewer can then vote. The method and system of the present inventive subject matter supports premium voting with micropayments, including paid voting which is a financial transaction involving a very small sum of money. Also the method and system supports large volumes of votes during a small timeframe within a live show or during an advertisement. Also provided is a mechanism or monetizing real-time context-related merchandizing. The price offers can be targeted based on the user viewer's profile. Also, the disclosed approach supports monetizing products in context to the show's course of events. The system and method may be offered as a service hosted on large web retailers supports large number of timeline requests per seconds, for both personalized and non-personalized requests. The system and method supports hundreds of millions of active users and dozens of millions of concurrent interaction events such as a live sport event where events are triggered following what is happening live on the program.

In summary the method and service of the present inventive subject matter addresses the needs of broadcasters, TV content production companies, TV advertisements agencies and brands seeking success through TV engagements. The method and system of the present inventive subject matter is an augmentation or supplement to television watching that enhances the television content and to focus the viewer's attention rather than a second screen application that takes the user viewer's attention away from the television broadcast. Thus the method and system provides a platform for: Interacting: enriching the viewing experience with relevant data and interactivity on companion devices; Creating: providing a highly scalable and reliable technological infrastructure to develop new social television formats that increase the potential of “social TV”; Advertising: the subscriber advertisers and the brands can identify the specific consumers who showed interest in the advertised product/brand/service and enable broadcasters to monetize advertisements based on actual engagements; Engaging: content producers, TV networks, advertisers and brands can create better, more meaningful interactions with their viewers and provide personalized experience in context to the user viewer's profile; Monetizing: content producers, TV networks, advertisers and brands can leverage the broadcaster viewers' engagement to generate new revenue streams by monetizing real-time social engagements on large scales; Scaling: content producers, TV networks, advertisers and brands can offer the social engagements on large scales (hundreds of millions of active users and dozens of millions of concurrent interaction).

The content management server with analytics is illustrated as being remote relative to the mobile device. However, it is specifically contemplated that some or all of the features of the content management server, for example, can be integrated into the mobile device. In such embodiments, information can be exchanged through an application program interface (API) or other suitable interface. In other embodiments, the analytics server or other components can comprise a distal computing server or a distributed computing platform.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A computer-implemented method of session management of data between a content management server and a plurality of interconnected remote devices over network, the computer-implemented method comprising:
sensing, through a remote device having at least one sensor, broadcast information from a broadcast device in sensor range;
recognizing the broadcast information;
storing, in an audience trends database through a network, recognized broadcast information from at least one of said remote devices;
storing in a broadcast database, information related to broadcasts; and
executing, by a content management server coupled to the audience trends database and broadcast database, stored software instructions that correlate data in the audience trends database with the broadcast database to derive content relevant analytics data.

2. The computer-implemented method of session management of data of claim 1 further comprising the step of determining the number of user viewers during a recognized broadcast program from said content relevant analytics data.

3. The computer-implemented method of session management of data of claim 2 further comprising the step of displaying the number of user viewers of recognized program in real time.

4. The computer-implemented method of session management of data of claim 2 further comprising the step of determining a program phase of a recognized program based upon the number of user viewers.

5. The computer-implemented method of session management of data of claim 2 further comprising the step of identifying a ramp up program phase of an increasing number of user viewers of a recognized broadcast over a predetermined period of time.

6. The computer-implemented method of session management of data of claim 2 further comprising the step of identifying a ramp down program phase of a decreasing number of user viewers of a recognized broadcast over a predetermined period of time.

7. The computer-implemented method of session management of data of claim 2 further comprising the step of identifying a peak program phase of the largest number of user viewers during a broadcast.

8. The computer-implemented method of session management of data of claim 2 further comprising the step of identifying a presentation phase by monitoring number of user viewers of a recognized broadcast over a predetermined period of time.

9. The computer computer-implemented method of session management of data of claim 4 further comprising the step of displaying program phases through a graphical user interface generated by said content management server.

10. The computer computer-implemented method of session management of data of claim 9 further comprising the step of permitting access of the graphical user interface by third party subscribers.

11. The computer computer-implemented method of session management of data of claim 10 further comprising the step of alerting third party subscribers of program phases.

12. The computer computer-implemented method of session management of data of claim 11 wherein said program phases comprise at least the following: a ramp up program phase of an increasing number of user viewers of a recognized broadcast over a predetermined period of time, a ramp down program phase of a decreasing number of user viewers of a recognized broadcast over a predetermined period of time, a peak program phase of the largest number of user viewers during a broadcast; and a presentation phase by monitoring number of user viewers of a recognized broadcast over a predetermined period of time.

13. The computer-implemented method of session management of data of claim 1 further comprising the step of storing the relevant analytics data onto an analytics database accessible over a network.

14. The computer computer-implemented method of session management of data of claim 1 further comprising the step of displaying relevant analytics data through a graphical user interface.

15. The computer computer-implemented method of session management of data of claim 1 further comprising the step of allowing a third party access to the relevant analytics data through a graphical user interface.

16. The computer computer-implemented method of session management of data of claim 15 further comprising the step of displaying information regarding user viewership of broadcasted programs during a selected time period.

17. The computer-implemented method of session management of data of claim 1 further comprising the step of monitoring user activity of remote devices.

18. The computer-implemented method of session management of data of claim 17 further comprises the step of storing, in the user trends database, user activity of said remote devices.

19. The computer-implemented method of session management of data of claim 18 where said user activity includes at least one of the following: remote device GPS data, number of remote device user interactions during the recognized broadcast and duration of remote device user interactions during the recognized broadcast.

20. The computer-implemented method of session management of data of claim 1 further comprising the step of accessing electronic program guide information.

21. The computer-implemented method of session management of data of claim 20 further comprises the step of storing, in the user trends database, electronic program guide information related to a recognized program.

22. A computer-implemented method of session management of data between a content management server and a plurality of interconnected remote devices over network, the computer-implemented method comprising:
monitoring user remote device activity;
sensing, through a remote device having at least one sensor, broadcast information from a broadcast device in sensor range;
recognizing the broadcast information;
accessing an electronic program guide related to the recognized broadcast information;
storing, in an audience trends database through a network, recognized broadcast information, user remote device activity and electronic program guide information from at least one of said remote devices; and
executing, by a content management server coupled to the audience trends database stored software instructions that correlate data in the audience trends database to derive content relevant analytics data;
determining the number of user viewers during a recognized broadcast program from said content relevant analytics data;
determining a program phase of a recognized program based upon the identified number of user viewers during a predetermined period of time; and
generating an alert upon determining a program phase;

23. The computer-implemented method of session management of data of claim 22 further comprises the step of generating content to be displayed on said at least one remote device in response to said alert.

24. The computer-implemented method of session management of data of claim 23 wherein said content to be displayed on said at least one remote device is at least one of the following: browser content, banner advertisement, SMS message or content displayed in a device application.

25. A computer-implemented data session management system, comprising:
a content management server coupled to a broadcast information database, said content management server including a computing device having a processor configured to execute stored software instructions;
wherein said content management server is further configured to:
receive user interaction context data from a plurality of remote devices over a network;
correlate said user interaction context data to broadcast information from said broadcast information database to derive content relevant analytics data; and
providing access to said content relevant analytics data to at least one data subscriber.

26. The session data management system of claim 25 further comprising an agent on board said plurality of remote devices configured to:
monitor the activities of a user in using a remote device;
sensing broadcast information from a broadcast device in sensor range;
recognizing the broadcast information;
transmitting the recognized broadcast information;
receiving content related to the recognized broadcast information from said content management server; and
displaying content relevant to the broadcast on said remote device.

27. The session data management system of claim 26 wherein said broadcast information is audio based information.

28. The session data management system of claim 26 wherein said broadcast information is imaged based information.

29. The session data management system of claim 26 wherein said broadcast information is an electronic programming guide.

30. The data session management system of claim 25 wherein said user interaction context data comprises at least one of the following: remote device GPS data, the number of remote device user interactions during the recognized broadcast, the duration of remote device user interactions during the recognized broadcast and interactive responses input by a user of a remote device.

31. The data session management system of claim 25, wherein said at least one data subscriber is capable of delivering advertising content to said at least one of said remote devices.

32. The data session management system of claim 25 further comprising an advertising push engine coupled to said content management server, said advertising push engine including a computing device having a processor to execute stored software instructions, said advertising push engine capable of delivering advertising content to said at least one of said remote devices.

33. The data session management system of claim 32 wherein said advertising push engine delivers advertising content to at least one of said remote devices in response to receiving analytics data meeting a predetermined criteria.

34. The data session management system of claim 26 wherein said broadcast device is a television.

35. The data session management system of claim 26 wherein said broadcast device is a radio.
